(19) United States
(12) Patent Application Publication
(10) Pub. No.: US 2003/0215778 A1
(43) Pub. Date: Nov. 20, 2003

(54) "Electro-nucleo genesoids" unlimited energy by matter-antimatter production-separation using using electromagnetic fields

(76) Inventor: Peter Paul M. Catalasan, Harbor City, CA (US)

Correspondence Address: Peter Paul Catalasan, 25410 Dodge Ave # K, Harbor City, CA, 90710, US

(21) Appl. No.: 10/074,908

(22) Filed: May 15, 2002

(51) Int. Cl. G09B 23/06

(52) U.S. Cl. 434/300

(57) ABSTRACT

Many scientists, especially Physicists, have always followed the Law of the Conservation of Mass and Energy. Guess what? I am that Physicist! Given an Associate of Arts in Physics from the University of California at Riverside and a Bachelor of Science in both Professional Mathematics and Computer Science, I stumbled with surprise on a very unique undiscovered theoretical process of Unlimited Energy by Matter-Antimatter Production and Separation that follows the Law of the Conservation of Mass and Energy! Given this discovery and explanation, many applications beneficial to our society will be stated and claimed in this Patent Application.

### TABLE OF CONTENTS

I. Field of Invention

II. Summary of Invention

III. System Drawings

IV. Brief Description of Drawings

V. Brief Description of the preferred Embodiments

### I. FIELD OF THE INVENTION

The established knowledge necessary to understand requires only simple algebra, elementary particle physics, and electromagnetic fields, in a very theoretical form for understanding Electro-Nucleo Genesoids, the name I chose since this process is entirely new. The word, “Genesoids,” will be clearer after I have introduced and explained the Unlimited Energy process. Please keep an open mind and it is actually very simple.

### II. SUMMARY OF THE INVENTION

At the Berkeley High Energy Bubble Chamber Laboratory, a particle and antiparticle was discovered and seen produced in empty space independent of any outside influence. The reason why this is possible is that a particle, E=mc², and antiparticle, −E=mc², when their Energies are added together, equals zero, conserving the law of the conservation of mass and energy, in which they annihilate back to zero when the particle and antiparticle combine again due to their opposite electrical charge. What happens when you keep the particle and antiparticle from annihilating back to zero? This is the profound crux of unlimited energy! If you entice and produce more particles and antiparticles and completely separate them through an electromagnetic barrier you will create an unlimited supply of matter on one side and an unlimited supply of antimatter on the other side. In other words, “Enticing” more pairs to be produced in space and keeping the pairs continually separated, through maybe an electromagnetic system, causes a build up of matter, which can be used for energy and to discard the remains of the antimatter. This would, mathematically and theoretically, produce unlimited energy because of the fact that energy of one matter unit equivalent to E=mc² is greater than the electromagnetic separation energy, Eₛ, and enticement energy, Eₑ, between the matter and the antimatter pair.

With this concept of unlimited energy, I speculated further and found how God created the universe because the universe has infinite energy mainly in the form of matter. So, in a sense, God created the universe through this method, which nullifies the Big Bang Creation Theory, because the latter disobeys the law of the conservation of mass and energy. Thus, I have named this process as Electro-Nucleo Genesoids because it generates Energy or Matter from virtually nothing, which is empty space.

### III. SYSTEM DRAWINGS

Please see drawing pages.

### IV. BRIEF DESCRIPTION OF DRAWINGS

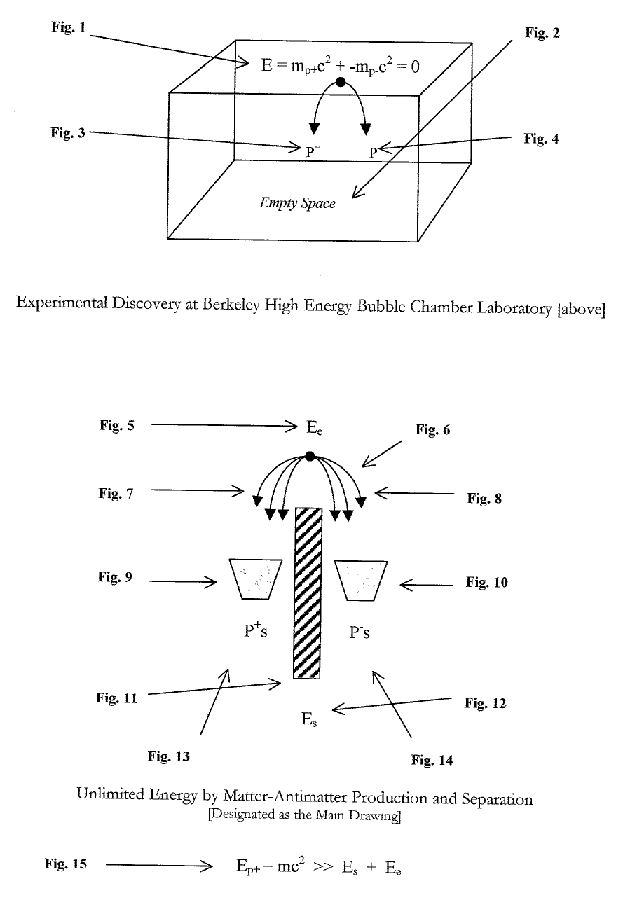

The Box Diagram, FIG. 2, is Empty Space with no Energy or Mass of any sort and completely empty. Given this, a discovery at the Berkeley Laboratories by scientists saw a path of two particles, FIG. 3 & FIG. 4, produced in Empty Space as a particle and antiparticle. This is possible since by FIG. 1, the conservation of mass and energy holds because E=mₚ₊c²+−mₚ₋c²=0.

The next diagram is my personal discovery of Unlimited Energy by Matter-Antimatter Production and Separation. Given an Enticement Energy, Eₑ, FIG. 5, a production of matter, FIG. 7, and antimatter, FIG. 8, is produced in space, FIG. 6. If we apply an Electromagnetic Barrier, FIG. 11, with Separation Energy, Eₛ, FIG. 12, we can obtain an unlimited supply of matter, FIGS. 9 & 13, and antimatter, FIGS. 10 & 14. And if we discard the antimatter, then Eₚ₊=mc² is so much greater than the antimatter Separation Energy, FIG. 12, and Enticement Energy, FIG. 15.

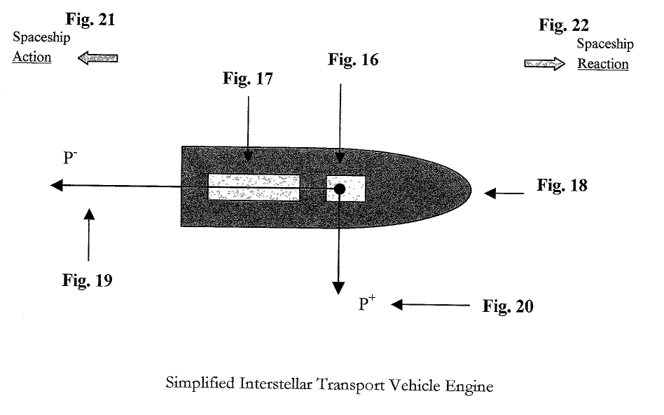

The Spaceship Diagram is a simplified Interstellar Transport Vehicle Engine such that the antimatter, FIG. 19, produced, FIG. 16, is accelerated by electromagnetic means, FIG. 17, by using the matter, FIG. 20, produced, FIG. 16, as the energy source to accelerate the antimatter. This causes a Reaction, FIG. 22, in Empty Space by an equal and opposite Action, FIG. 21, causing the Spaceship to be propelled in Empty Space

### IV. DESCRIPTION OF PREFERRED EMBODIMENTS

In Empty Space, FIG. 2, Drawing Page, at the Berkeley High Energy Bubble Chamber Laboratory, a path of two particles was seen produced in the Bubble Chamber independent of outside influence, later to be discovered as particles and antiparticles, since they have opposite charge and energy, it was the first experimental evidence of this nature.

The Matter and Antimatter, FIG. 3 & FIG. 4, is the notation of physicists to describe matter and antimatter produced in Empty Space.

The Total Energy of the System in Empty Space, FIG. 1, is Zero even when matter and antimatter is produced since they have opposite charge and matter energy. In other words, E=mₚ₊c²+−mₚ₋c²=0.

The Enticement Energy, FIG. 5, Eₑ, is responsible for the creation of matter and antimatter. The magnitude of this energy is very low due to the fact that matter and antimatter is produced even without this energy, particle, or field.

The Productions of Matter and Antimatter, FIG. 6, given Enticement Energy, need to be physically separated by an electromagnetic field or Electromagnetic Separation with Energy, FIG. 11, Eₛ.

The Matter, FIG. 7, after being separated from the antimatter, is stored in the Matter Container, FIG. 9.

The Antimatter, FIG. 8, similarly, after being separated from the matter, is stored in the Antimatter Container, FIG. 10.

The Matter Container, FIGS. 9 & 13, is an electromagnetic field storage for all the matter generated.

The Antimatter Container, FIGS. 10 & 14, is also an Electromagnetic Field Storage for all the antimatter generated such that particles do not touch the container; i.e. if antimatter touches ordinary matter it may disappear of explode.

The Electromagnetic Separation Barrier, FIG. 11, is a Theoretical Electromagnetic Field, not defined yet but will be defined when experiments are actually made, that separates the matter and antimatter produced by the enticement energy, particle, or field, FIG. 5.

The Electromagnetic Separation Energy, FIG. 12, is the Energy required to sustain the Electromagnetic Separation Barrier, FIG. 11.

The Total Energy of the System, FIG. 15, is the Energy gained by matter antimatter production and separation such that the positive matter is used for energy and to discharge the antimatter. Thus, there is actually energy gained! In other words, Eₚ₊=mc²>>Eₛ+Eₑ, where Eₚ₊, FIG. 13, is the energy of the matter and Eₛ, FIG. 12, is the Electromagnetic Separation Energy, and Eₑ, FIG. 5, is the Electromagnetic Enticement Energy.

The Simplified Interstellar Transport Vehicle Engine, FIG. 18, Page 4, is a simplified example of the use of Electro-Nucleo Genesoids.

The Electro-Nucleo Genesoid. FIG. 16, creates matter and antimatter on its own so that matter is used for energy to accelerate, FIG. 17, and to discharge the antimatter, FIG. 19, in Space

The Accelerator, FIG. 17, is a Cyclotron Accelerator already developed and used in Science that accelerates the antimatter.

The Antimatter FIG. 19, generated by the Electro-Nucleo Genesoid, is thrown out of the Spaceship, FIG. 18.

The Matter, FIG. 20, generated by the Electro-Nucleo Genesoid, is converted to energy for the use of the Spaceship and the acceleration of the antimatter.

The Spaceship Action, FIG. 21, is to discharge and accelerate the antimatter to produce an equal and opposite reaction in Space.

The Spaceship Reaction, FIG. 22, is propelled forward into Space.

Since there is Energy gained, Electro-Nucleo Genesoids gives us an inexhaustible supply of Energy beneficial to our society for consumption on earth and in Solar and Interstellar Space, where the Spaceship is provided with more detail in another Patent Application called “Interstellar Transport Vehicle Engine.”

The name Electro-Nucleo Genesoid is due to my discovery of how God created the Universe, since the Universe has infinite energy in the form of matter! According to the Big Bang Creation Theory, the Universe was created without the existence of God. If you look at our Milky Way Galaxy, scientists already have proof of planets orbiting around each star. How can all this beautiful and organized matter form without an intelligent designer? Moreover, the probability of a complex well-ordered system generated from nothing has the probability of being so close to zero that, as mathematicians and scientist say, it is Zero. Thus, I Believe, the Big Bang is a Big Zero

### ACRL™

### Advanced Catalasan Research Laboratories, Inc

This Work is dedicated to my Most Intelligent Brother, Manolito Catalasan, who invited Peter Paul Catalasan to study Physics at the University of California at Riverside, upon which Peter Paul became the first to discover Unlimited Energy through Matter/Antimatter Production/Separation.

Having the knowledge of Unlimited Energy, we can apply such energies to overcome long distances through the use of Einstein's properties of Relativity upon which many equations have negative time dependency related to the speed of light. For example, if it takes one million light-years to get to another Galaxy, why not go back in time for one million light-years while traveling there, therefore arriving at t=0.

Given this opportunity, and a coordinated research effort between Valentino Catalasan, Victor Catalasan, and Peter Paul Catalasan, we can form an Advanced Research Laboratory, called the Advanced Catalasan Research Laboratory, Inc, or ACRL, which will spin off to a committed effort for any Noble Research Activity, where Manolito, as Chief Executive Officer, will own the Research Information. The responsibilities of research and development come from Valentino Catalasan—Chief Technology Officer, Peter Paul Catalasan—Research Director, and Victor Catalasan—Engineering Physicist. We all have Technological First Loves, Computer Science for Valentino, Physics for Peter Paul, Engineering for Victor, and the Last Star Fighter Austin Catalasan.

Electro-Nucleo Genesoids Current Claims are as follows:

1. Creation of the Universe

2. Inexhaustible Supply of Matter and Energy

3. Generator of Particles and Antiparticles

4. Simple Interstellar Transport Vehicle Engine

5. Commercial & Experimental use of Matter Generation
